(19) United States
(12) Patent Application Publication
(10) Pub. No.: US 2006/0068366 A1
(43) Pub. Date: Mar. 30, 2006

(54) System for entertaining a user

(76) Inventors: Edmond Chan, Fort Worth, TX (US); David K. Mathews, Fort Worth, TX (US)

Correspondence Address: LAW OFFICE OF DONALD D. MONDUL, 3060 Bonsai Drive, Plano, TX, 75093, US

(21) Appl. No.: 10/942,304

(22) Filed: Sep. 16, 2004

(51) Int. Cl. G09B 5/00

(52) U.S. Cl. 434/169

(57) ABSTRACT

A system for entertaining a user includes: (a) an anthropoid apparatus having a first processing unit coupled with a plurality of sensor input devices including at least one radio frequency identification receiver device; each respective sensor input device being an originating sensor input device providing a respective sensor signal to the first processing unit; each respective sensor input signal indicating a respective parameter sensed by its respective originating sensor input device; (b) a plurality of accessory items for use with the apparatus; at least one selected accessory item bearing a radio frequency identifying indicium; each respective radio frequency identifying indicium distinguishing a respective selected accessory item; the first processing unit being programmed to cooperate with the at least one radio frequency identification receiver device for recognizing the at least one selected accessory item by the radio frequency identifying indicium.

### BACKGROUND OF THE INVENTION

The present invention is directed to a system for entertaining a user, and especially to an anthropoid or human-like shaped apparatus, such as a doll, for entertaining children. Such anthropoid apparatuses include, by way of example and not by way of limitation, dolls in the shapes of children, monkeys, adult humans, whimsical characters and other limbed characters configured for dressing in clothing-like articles.

Dolls designed to perform some functions of a playmate have been designed before. Early dolls were designed with a capability to utter prerecorded words or phrases in response to an initiating action on the part of the human playmate-user. For example, such prior art doll may utter a phrase upon being moved, or upon having its abdomen or hand pressed by the user.

U.S. Pat. No. 6,629,133 to Philyaw et al. for “Interactive Doll” (hereinafter referred to as “Philyaw”) discloses a doll containing embedded sensors which respond to touch or other kinds of physical stimuli to output a signal to a tone generation circuit. Philyaw's tone generation circuit encodes predetermined information into an audible tone related to what sensor is activated according to unique identifying information for each sensor. The encoded audible tone is communicated to a personal computer (PC). The PC decodes the tone and responds accordingly.

U.S. Pat. No. 6,319,010 to Kikinis for “PC Peripheral Interactive Doll” (hereinafter referred to as “Kikinis”) discloses a doll having input and output elements (I/O elements), control circuitry for driving the I/O elements and a bi-directional communication link to a personal computer (PC). Kikinis's communication between the PC and the doll treats the doll as a peripheral device of the PC. The doll may have servo-mechanisms for providing doll motion which may be coordinated with verbalization in different scripts by commands retrieved at the PC and sent to the doll.

RFID (Radio Frequency Identification) technology has been employed in various applications involving identification of particular items, such as inventory and point of sale applications. Such an application used by Prada is described at http://www.ideo.com. Some have opined that a smart sensor can be implanted in the back of a doll that stores information about clothes and accessories that the doll “wants”. See http://www.digitalforum.accenture.com. Others have developed a smart doll able to react to RFID tagged objects and respond appropriately. For example, the doll can be programmed to buy only the latest fashions, or be limited to purchases that fit an “expense account”. See http://www.accenture.com.

No entertainment system, such as a doll, has yet been proposed or disclosed that can approximate interactive play with a user without having a communication link established with a computing apparatus, such as a PC, remote from the doll during play.

No entertainment system, such as a doll, has been proposed or disclosed that employs RFID technology to effect a link between accessories such as clothing and the system to compose phrases uttered by the system, or doll, using phraseology that is real-time associated with accessories used with the system and is associated with environmental conditions near the doll.

No entertainment system, such as a doll, has yet been proposed or disclosed that can use an internet link through a computing apparatus remote from the doll to effect updates in vocabulary of the system.

No entertainment system, such as a doll, has yet been proposed or disclosed that can communicate with other like systems or dolls directly without participation by a remote computer remote from communicating dolls.

### SUMMARY OF THE INVENTION

A system for entertaining a user includes: (a) an anthropoid apparatus having a first processing unit coupled with a plurality of sensor input devices including at least one radio frequency identification receiver device; each respective sensor input device being an originating sensor input device providing a respective sensor signal to the first processing unit; each respective sensor input signal indicating a respective parameter sensed by its respective originating sensor input device; (b) a plurality of accessory items for use with the apparatus; at least one selected accessory item bearing a radio frequency identifying indicium; each respective radio frequency identifying indicium distinguishing a respective selected accessory item; the first processing unit being programmed to cooperate with the at least one radio frequency identification receiver device for recognizing the at least one selected accessory item by the radio frequency identifying indicium.

It is, therefore, an object of the present invention to provide an entertainment system, such as a doll, for entertaining a user that can approximate interactive play with a user without having a communication link established with a computing apparatus remote from the doll, such as a PC, during play.

It is a further object of the present invention to provide an entertainment system, such as a doll, that employs RFID technology to effect a link between accessories such as clothing and the system to compose phrases uttered by the system, or doll, using phraseology that is real-time associated with accessories used with the system and is associated with environmental conditions near the doll.

Yet a further object of the present invention is to provide an entertainment system, such as a doll, that can use an internet link through a computing apparatus remote from the doll to effect updates in vocabulary of the system.

Still a further object of the present invention is to provide an entertainment system, such as a doll, that can communicate with other like systems or dolls directly without participation by a remote computer remote from communicating dolls.

Further objects and features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic diagram illustrating the preferred embodiment of the present invention.

FIG. 2 is a schematic diagram illustrating the preferred embodiment of the invention.

FIG. 3 is a schematic diagram illustrating communicating between two like systems configured according to the present invention.

FIG. 4 is a representative tool for use in composing phrases for utterance by the system of the present invention.

### DETAILED DESCRIPTION OF THE PREFERRED EMBODIMENT

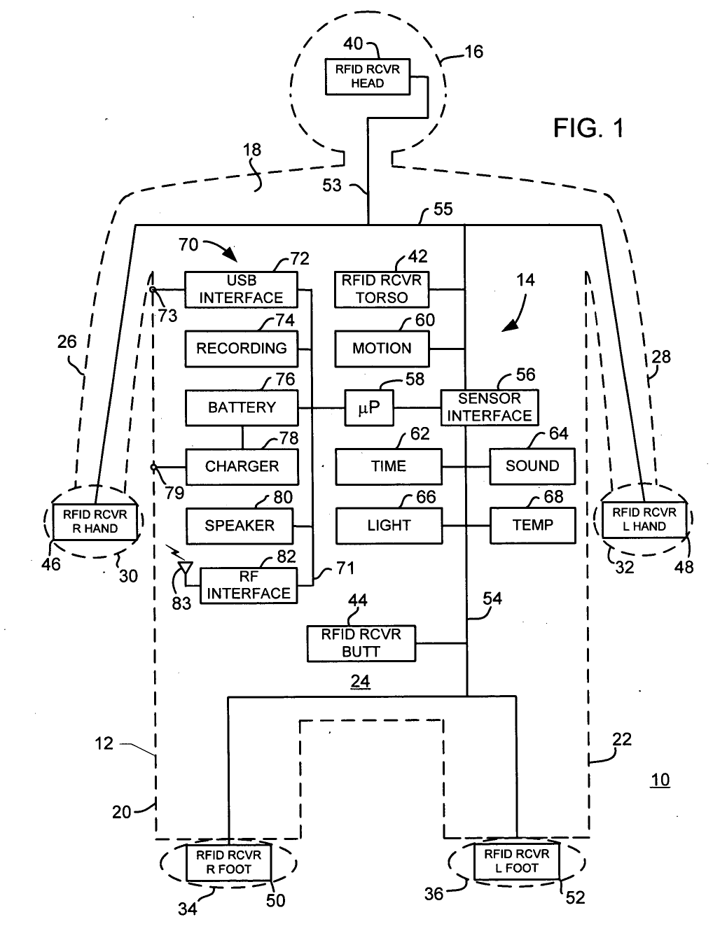

FIG. 1 is a schematic diagram illustrating the preferred embodiment of the present invention. In FIG. 1, a system 10 for entertaining a user (not shown in FIG. 1) includes an anthropoid apparatus 12 containing an array 14 of sensors. Anthropoid apparatus 12 may be configured, by way of example and not by way of limitation, as a doll in the shape of a child, in the shape of a monkey, in the shape of an adult human, in the shape of a whimsical character or in the shape of another limbed character configured for dressing in clothing-like articles. Anthropoid apparatus 12 includes a head 16 joined with a torso 18. Legs 20, 22 are connected with feet 34, 36 and depend from torso 18 at a butt area 24. Arms 26, 28 also depend from torso 18 and are connected with hands 30, 32.

Array 14 of sensors includes, by way of example and not by way of limitation, an RFID (Radio Frequency IDentification) receiver unit 40 located at head 16, an RFID receiver unit 42 located at torso 18, an RFID receiver unit 44 located at butt 24, RFID receiver units 46, 48 located at hands 30, 32 and RFID receiver units 50, 52 located at feet 34, 36. RFID receiver units 40, 42, 44, 46, 48, 50, 52 are coupled via buses 53, 54, 55 with a sensor interface unit 56. Sensor interface unit 56 is coupled with a microprocessor unit 58. Microprocessor unit 58 includes or is coupled with a memory storage unit (not shown in FIG. 1).

Array 14 of sensors also includes a plurality of environmental sensors such as, by way of example and not by way of limitation, a motion sensor 30 for sensing when apparatus 12 is moved, a time sensor 62 for indicating time of day or elapsed time or other time measurements, a sound sensor 64 for sensing sound level in the vicinity of apparatus 12, a light sensor 66 for detecting ambient light in the vicinity of apparatus 12 and a temperature sensor 68 for sensing temperature in the vicinity of apparatus 12. Environmental sensors 60, 62, 64, 66, 68 are coupled via buses 54, 55 with sensor interface unit 56. Sensor interface unit 56 is coupled with microprocessor 58.

System 10 also includes functional devices 70 for effecting operation of system 10. A USB (Universal Serial Bus) interface device 72 is coupled with microprocessor 58 via a bus 71. An external access locus 73 is coupled with USB interface device 72 to provide access to microprocessor 58 from without apparatus 12 via USB interface device 72 and bus 71. A recording device 74 is coupled with microprocessor 58 via bus 71. A battery 76 is coupled with microprocessor 58 via bus 71. A battery charging device 78 is coupled with battery 76. An external access locus 79 is coupled with battery charging device 78 to provide access to battery 76 from without apparatus 12 via battery charging device 78. A speaker 80 is coupled with microprocessor 58 via bus 71. An RF (Radio Frequency) interface device 82 is coupled with microprocessor 58 via bus 71. An antenna 83 is coupled with RF interface device 82 to provide RF access to microprocessor 58 via RF interface device 82 and bus 71.

RF interface device 82 permits apparatus 12 to wirelessly communicate with a PC (personal computer) or communicate with a similar computing device. RF interface device 82 also permits apparatus 12 to wirelessly communicate with other apparatuses (not shown in FIG. 1) configured similarly to apparatus 12. USB interface device 72 permits apparatus 12 to communicate with a PC (personal computer) or similar computing device via a USB cable, as well as communicate with another apparatus (not show in FIG. 1) configured similarly to apparatus 12 via a USB cable.

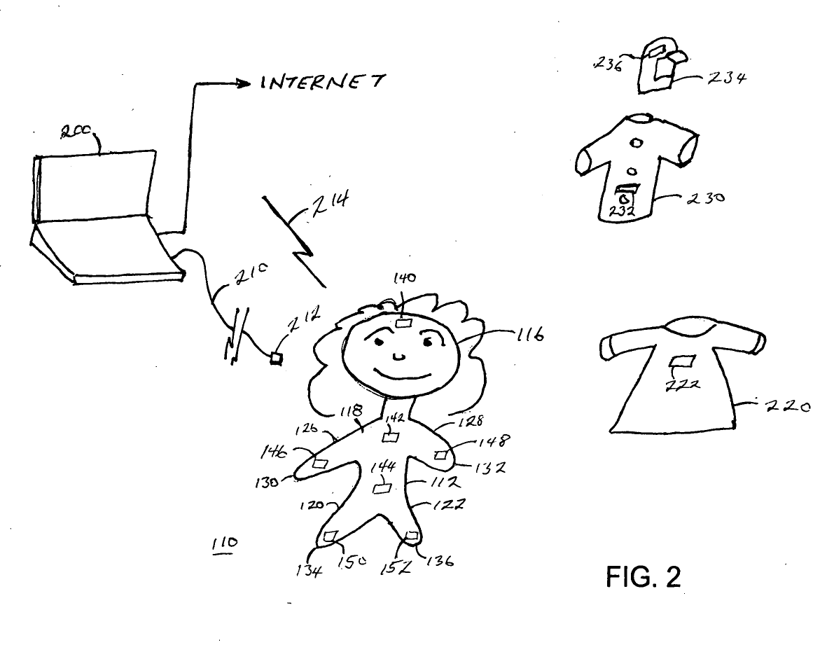

FIG. 2 is a schematic diagram illustrating the preferred embodiment of the invention. In FIG. 2, a system 110 for entertaining a user (not shown in FIG. 2) includes an anthropoid apparatus 112 outfitted, by way of example and not by way of limitation, as a doll in the shape of a child including a head 116 joined with a torso 118. Legs 120, 122 depend from torso 118. Arms 126, 128 also depend from torso 118 and are connected with hands 130, 132. Legs 120, 122 are connected with feet 134, 136.

Sensors in apparatus 112 include, by way of example and not by way of limitation, an RFID (Radio Frequency IDentification) receiver unit 140 located at head 116, an RFID receiver unit 142 located at torso 118, an RFID receiver unit 144 located above junction of legs 120, 122, RFID receiver units 146, 148 located at hands 130, 132 and RFID receiver units 150, 152 located at feet 134, 136. RFID receiver units 140, 142, 144, 146, 148, 150, 152 are coupled with a microprocessor unit (not shown in FIG. 2) substantially as described in connection with microprocessor unit 58 (FIG. 1).

Clothing and accessories are provided for use with apparatus 112 such as, by way of example and not by way of limitation, a dress 220, a raincoat 230 and a rain hat 234. Dress 220 has an RFID label 222 affixed that identifies dress 220. By way of example and not by way of limitation, RFID label 222 may be encoded with a series of digital codes, such as a series of numerals. A first numeral (0-9) may indicate color. A second numeral (0-9) may indicate style such as dress, pants or raincoat. Style may also indicate that the article bearing the RFID tag is an accessory such as a pony, a surfboard or a recreation vehicle. A third numeral (0-9) may indicate location such as inside, outside, beach or other location suitable for wearing the article of clothing or accessory. This coding arrangement is exemplary only; other coding arrangements may also be used while remaining within the scope of the present invention.

By placing dress 220 on apparatus 112, RFID tag 222 will be situated generally adjacent RFID receiver 142. The code on RFID tag 222 is read by RFID receiver 142 and passed to a microprocessor (e.g., microprocessor 58; FIG. 1). The microprocessor will have information stored in a memory storage unit to interpret the coding provided from RFID tag 222 sufficiently to generate a spoken phrase by apparatus 112 such as:
I like my BLUE [Code Numeral 1; color] DRESS [Code Numeral 2; style]. Let's go to A PARTY [Code Numeral 3; Location].

Other phrases can be generated in a fill-in-the-blank approach using code numerals from RFID tags affixed to clothing or accessories brought into range of RFID receiver units 140, 142, 144, 146, 148, 150, 152. Additional coding may be provided on RFID tags to more finely granulate response by apparatus 112. For example, added coding may be provided to require only certain RFID receiver units may read a particular RFID tag. Such a limitation would prevent a hand located RFID reader unit 146, 148 reading a shoe intended for reading by an RIFD reader unit 150, 152. Alternatively, other phrases may be generated by such misplaced accessories or clothes, such as:
Silly, you have put my SHOES [coding from RFID tag] on my HANDS [coding from RFID reader unit].

In similar fashion, by placing raincoat 230 on apparatus 112, RFID tag 232 will be situated generally adjacent RFID receiver 144. The code on RFID tag 232 is read by RFID receiver 144 and passed to a microprocessor (e.g., microprocessor 58; FIG. 1). The microprocessor will have information stored in a memory storage unit to interpret the coding provided from RFID tag 232 sufficiently to generate a spoken phrase by apparatus 112 such as:
I like my YELLOW [Code Numeral 1; color] RAINCOAT [Code Numeral 2; style]. Let's go to SCHOOL [Code Numeral 3; Location].

When two articles of clothing should be used together, apparatus 112 may note the absence of an accompanying article of clothing and remind the user. For example, the microprocessor in apparatus 112 (e.g., microprocessor 58; FIG. 1) may be programmed to know that when RFID tag 232 is read by RFID reader unit 144 there is supposed to be an RFID tag 236 being read by RFID reader unit 140. If raincoat 230 is placed on apparatus 112 without rain hat 234, a phrase may be generated to advise the user that rain hat 234 is missing.

Apparatus 112 may communicate with a computer 200 via a USB cable 210 fitted with a connector 212 configured to engage external access locus 73 of USB interface device 72 (FIG. 1). Alternatively, apparatus 112 may communicate with computer 200 wirelessly, as indicated at 214, using antenna 83 of RF interface 82 (FIG. 1). Connection with computer 200 enables apparatus 112 to communicate via the Internet or other network to access material provided by a manufacturer or provider of apparatus 12 (not shown in FIG. 2). A manufacturer may provide updated material for apparatus 112 in terms of phrase construction, new clothes or accessories purchased, availability of new clothes or accessories for purchase. Generally, phraseology provided for use by apparatus 112 is clothing/accessory driven. By that is meant, for example, that a change in clothing style from a conservative button-down collar style to a hip-hop style may cause the phrase generating routines in the microprocessor in apparatus 112 to be updated via the Internet to generate hip-hop phrases when wearing hip-hop style clothes. Updates can also change accent of spoken phrases to reflect a regional accent or dialect, such as a Southern accent or a Boston accent. References to events or people or other time-dependent indicators may be changed during an update. An update may also alter vernacular used in phraseology, alter references to pop music or movie icons or reflect other cultural or popularity changes over time. Updates may be used to change the language used by apparatus 12 such as from English to Spanish or French. Updates may be made by other means than the Internet, such as by CD-ROM, DVD or other media loaded into computer 200.

Knowing what clothing is available (downloaded during an update and stored in the memory storage unit) permits the apparatus to utter a phrase such as:
I want a NAME ITEM for Christmas.

This feature is described to illustrate the flexibility of apparatus 112. It is up to the marketing staff of manufacturers of apparatus 112 whether they think this capability would be appreciated by parents of users of apparatus 112.

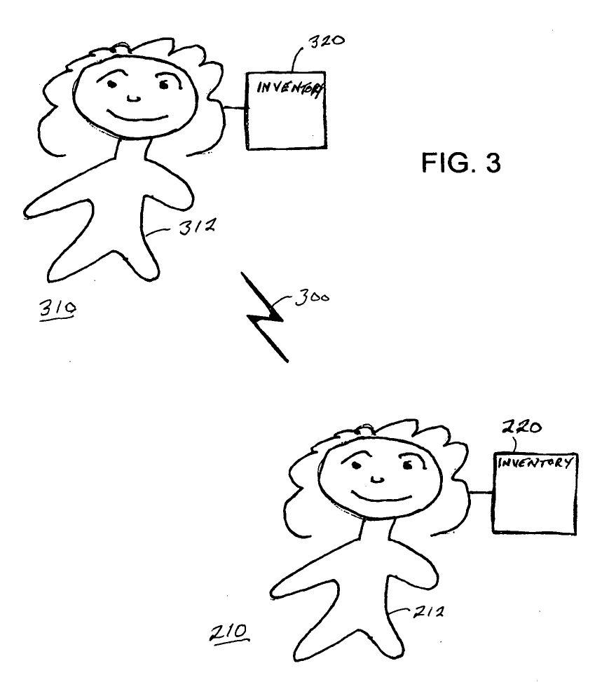

FIG. 3 is a schematic diagram illustrating communicating between two like systems configured according to the present invention. In FIG. 3, a first system 210 and a second system 310 are within communication range to effect wireless communication between an apparatus 212 and an apparatus 312, as indicated by 300. Generally the range at which it is desired that communications occur is on the order of tens of feet—preferably up to about 10-20 feet. Essentially, systems 210, 310 employ their respective RF interfaces and associated antennas (e.g., RF interface device 80, antenna 83; FIG. 1) to establish a piconet of appropriate size, range and power that no interference is produced with other wireless networks or wireless controllers in a home or office environment.

Apparatus 212 includes a memory storage unit 220 that lists inventory of clothing and accessories “owned” by apparatus 212 (i.e., listed as held in memory storage unit 220). Apparatus 312 includes a memory storage unit 320 that lists inventory of clothing and accessories “owned” by apparatus 312 (i.e., listed as held in the memory storage unit 320). Preferably, each respective memory storage unit 220, 320 includes RFID tag information usable by microprocessors in apparatuses 212, 312 (e.g., microprocessor 58; FIG. 1) to read information from RFID tags in the clothing and accessories to form appropriate phrases relating to the clothing and accessories. Such listings or inventories in memory storage units 220, 320 permit apparatuses 212, 312 to “converse” during the duration of a piconet between them (established as described in connection with FIG. 2) so that systems 212, 312 may borrow clothing or accessories from each other. Appropriate phrase generation may be effected using RFID tag information in respective memory storage units 220, 320, such as:
May I borrow your RED [Code Numeral 1; color] SUN HAT [Code Numeral 2; style] so we can go to THE BEACH [Code Numeral 3; Location].

Other information may be included in memory storage units 220, 320 for exchange in a piconet, such as name, favorite color, favorite girl singer, favorite boy group and other preferences. Such personal preferences are preferably capable of being entered into memory storage units 220, 320 by a user using a computer and a USB cable or wireless interface, as described in connection with FIG. 2.

By apparatuses 212, 312 sharing information in storage units 220, 320 each respective apparatus 212, 312 knows what is “owned” by the other apparatus 212, 312. Using this knowledge permits an apparatus 212, 312 to utter a phrase such as:
I want a NAME ITEM [based upon RFID code] just like NAME OTHER APPARATUS has.

This feature is described to illustrate the flexibility of apparatuses 212, 312. It is up to the marketing staff of manufacturers of apparatuses 212, 312 whether they think this capability would be appreciated by parents of users of apparatuses 212, 312.

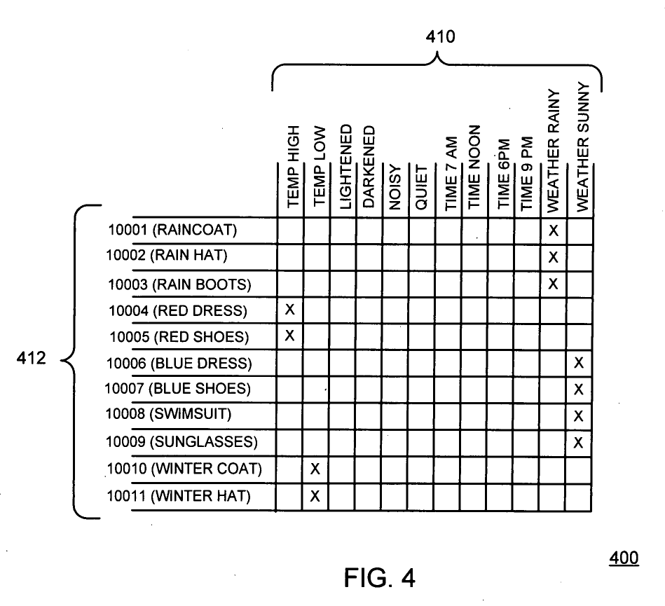

FIG. 4 is a representative tool for use in composing phrases for utterance by the system of the present invention. In FIG. 4, a matrix 400 includes rows 410 indicating sensor inputs and columns 412 indicating RFID (Radio Frequency IDentification) codes read from RFID tags on clothing and accessories (not shown in FIG. 4) associated with the system of the present invention. Sensor inputs arrayed in rows 410 preferably include environmental sensor inputs generally indicating conditions in the vicinity of the system.

By way of example and not by way of limitation, a system employing matrix 400 that experiences a high temperature condition will compose a phrase:
I'm HOT [environmental sensor input]. Please put on my RED DRESS [system knows that it “owns” a red dress (RFID code 10004); inventory in memory storage unit].

The system may be programmed to recognize that when red shoes are “owned”, the red shoes and red dress are an ensemble. In such circumstances, the system will compose a phrase such as:
Please don't forget my RED SHOES [system knows that it “owns” red shoes (RFID code 10005); inventory in memory storage unit].

A system employing matrix 400 that experiences a low temperature condition will compose a phrase:
I'm COLD [environmental sensor input]. Please put on my WINTER COAT [system knows that it “owns” a winter coat (RFID code 10010); inventory in memory storage unit].

The system may be programmed to recognize that when a winter hat is “owned”, the winter coat and winter hat are an ensemble. In such circumstances, the system will compose a phrase such as:
Please don't forget my WINTER HAT [system knows that it “owns” a winter hat (RFID code 10011); inventory in memory storage unit].

A system employing matrix 400 that receives a rainy weather prediction will compose a phrase:
It's going to be RAINY today [weather condition sensor input], please put on my RAINCOAT [system knows that it “owns” a raincoat (RFID code 10001); inventory in memory storage unit].

The system may be programmed to recognize that when a rain hat and rain boots are “owned”, the raincoat, rain hat and rain boots are an ensemble. In such circumstances, the system will compose a phrase such as:
Please don't forget my RAIN HAT AND RAIN BOOTS [system knows that it “owns” a rain hat (RFID code 10002) and rain boots (RFID code 10003); inventory in memory storage unit].

Weather prediction input may be sensed from an Internet or other network connection updated periodically or from a web site offered via the Internet or another network by a manufacturer or marketer of the system.

A system employing matrix 400 that receives a sunny weather prediction will compose a phrase:
It's going to be SUNNY today [weather condition sensor input], please put on my BLUE DRESS [system knows that it “owns” a blue dress (RFID code 10006); inventory in memory storage unit].

The system may be programmed to recognize that when blue shoes are “owned”, the blue dress and blue shoes are an ensemble. In such circumstances, the system will compose a phrase such as:
Please don't forget my BLUE SHOES [system knows that it “owns” blue shoes (RFID code 10007); inventory in memory storage unit].

Alternatively, when a system employing matrix 400 that receives a sunny weather prediction it will compose a phrase:
It's going to be SUNNY today [weather condition sensor input], please put on my SWIMSUIT [system knows that it “owns” a swimsuit (RFID code 10008); inventory in memory storage unit].

The system may be programmed to recognize that when sunglasses are “owned”, the swimsuit and sunglasses are an ensemble. In such circumstances, the system will compose a phrase such as:
Please don't forget my SUNGLASSES [system knows that it “owns” sunglasses (RFID code 10009); inventory in memory storage unit].

Another alternative is to have the sunglasses also be included in an ensemble with other sunny day outfits, such as the blue dress and blue shoes ensemble.

A system employing matrix 400 that notes the time is approaching Noon may compose a phrase:
It's almost time for LUNCH [time sensor input]. Let's eat.

Using such a fill-in-the-blanks approach to phrase composition one may employ a wide variety of environmental sensor inputs and RFID code inputs to provide for a large number of phrases for utterance by the system through the apparatus. It is desirable that a large number of phrases be preset for fill-in-the-blank utilization in connection with matrix 400 in order to avoid boredom by a user and in order to simulate real conversation by the apparatus posing as a playmate.

Matrix 400 is illustrated as a two-dimensional matrix in order to simplify explanation of the invention. Matrices of greater numbers of dimensions may be provided in memory storage units in order to provide greater variety and complexity for the phrase composition capability of the present invention.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims:

I claim:

1. A system for entertaining a user; the system comprising:
(a) an anthropoid apparatus; said apparatus having a first processing unit coupled with a plurality of sensor input devices; said plurality of sensor input devices including at least one radio frequency identification receiver device; each respective sensor input device of said plurality of sensor input devices being a respective originating sensor input device providing a respective sensor signal to said first processing unit; each said respective sensor input signal indicating a respective parameter sensed by its respective originating sensor input device;
(b) a plurality of accessory items for use with said apparatus; at least one selected accessory item of said plurality of accessory items bearing a radio frequency identifying indicium; each said respective radio frequency identifying indicium distinguishing a respective said selected accessory item;
said first processing unit being programmed to cooperate with said at least one radio frequency identification receiver device for recognizing said at least one selected accessory item by said radio frequency identifying indicium.

2. A system for entertaining a user as recited in claim 1 wherein the system further comprises an audio speaker device coupled with said first processing unit.

3. A system for entertaining a user as recited in claim 2 wherein said first processing unit, at least one said respective originating sensor input device and said audio speaker device cooperate to produce an audible phrase; said audible phrase being related with at least one said sensor input signal received by said processing unit from at least one said respective originating sensor input device.

4. A system for entertaining a user as recited in claim 1 wherein said apparatus is configured to represent a torso, a head and a plurality of limbs; said plurality of limbs including two arms and two legs; said at least one radio frequency identification receiver devices being at least a respective radio frequency identification receiver device situated in said torso, situated in said head and attached with selected limbs of said plurality of limbs.

5. A system for entertaining a user as recited in claim 2 wherein said apparatus is configured to represent a torso, a head and a plurality of limbs; said plurality of limbs including two arms and two legs; said at least one radio frequency identification receiver devices being at least a respective radio frequency identification receiver device situated in said torso, situated in said head and attached with selected limbs of said plurality of limbs.

6. A system for entertaining a user as recited in claim 3 wherein said apparatus is configured to represent a torso, a head and a plurality of limbs; said plurality of limbs including two arms and two legs; said at least one radio frequency identification receiver devices being at least a respective radio frequency identification receiver device situated in said torso, situated in said head and attached with selected limbs of said plurality of limbs.

7. A system for entertaining a user as recited in claim 1 wherein said first processing unit is accessible from without said apparatus for communication with a second processing unit.

8. A system for entertaining a user as recited in claim 2 wherein said first processing unit is accessible from without said apparatus for communication with a second processing unit.

9. A system for entertaining a user as recited in claim 3 wherein said first processing unit is accessible from without said apparatus for communication with a second processing unit.

10. A system for entertaining a user as recited in claim 4 wherein said first processing unit is accessible from without said apparatus for communication with a second processing unit.

11. A system for entertaining a user as recited in claim 5 wherein said first processing unit is accessible from without said apparatus for communication with a second processing unit.

12. A system for entertaining a user as recited in claim 6 wherein said first processing unit is accessible from without said apparatus for communication with a second processing unit.

13. A system for entertaining a user as recited in claim 9 wherein said first processing unit cooperates with said second processing unit to alter said audible phrase for at least one combination of signals provided to said first processing unit from said at least one respective originating sensor input device.

14. A system for entertaining a user as recited in claim 10 wherein said first processing unit cooperates with said second processing unit to alter said audible phrase for at least one combination of signals provided to said first processing unit from said at least one respective originating sensor input device.

15. A system for entertaining a user as recited in claim 11 wherein said first processing unit cooperates with said second processing unit to alter said audible phrase for at least one combination of signals provided to said first processing unit from said at least one respective originating sensor input device.

16. A system for entertaining a user as recited in claim 12 wherein said first processing unit cooperates with said second processing unit to alter said audible phrase for at least one combination of signals provided to said first processing unit from said at least one respective originating sensor input device.

17. A system for entertaining a user as recited in claim 1 wherein said first processing unit is powered by a battery device in said apparatus.

18. A system for entertaining a user as recited in claim 3 wherein said first processing unit is powered by a battery device in said apparatus.

19. A system for entertaining a user as recited in claim 16 wherein said first processing unit is powered by a battery device in said apparatus.

20. A system for entertaining a user as recited in claim 17 wherein said battery device is accessible from without said apparatus for effecting battery charging operations.

21. A system for entertaining a user as recited in claim 18 wherein said battery device is accessible from without said apparatus for effecting battery charging operations.

22. A system for entertaining a user as recited in claim 19 wherein said battery device is accessible from without said apparatus for effecting battery charging operations.

23. A system for entertaining a user; the system comprising:
(a) an anthropoid apparatus; said apparatus being configured to represent a torso a head and a plurality of limbs including two arms and two legs; said apparatus having a first processing unit coupled with a plurality of sensor input devices; said plurality of sensor input devices including at least one radio frequency identification receiver device; each respective sensor input device of said plurality of sensor input devices being a respective originating sensor input device providing a respective sensor signal to said first processing unit; each said respective sensor input signal indicating a respective parameter sensed by its respective originating sensor input device; said at least one radio frequency identification receiver device being at least a respective radio frequency identification receiver device situated in said torso, situated in said head and attached with selected limbs of said plurality of limbs;
(b) a plurality of accessory items for use with said apparatus; at least one selected accessory item of said plurality of accessory items bearing a radio frequency identifying indicium; each said respective radio frequency identifying indicium distinguishing a respective said selected accessory item;
said first processing unit being programmed to cooperate with said at least one radio frequency identification receiver device for recognizing said at least one selected accessory item by said radio frequency identifying indicium.

24. A system for entertaining a user as recited in claim 23 wherein the system further comprises an audio speaker device coupled with said first processing unit.

25. A system for entertaining a user as recited in claim 24 wherein said first processing unit, at least one said respective originating sensor input device and said audio speaker device cooperate to produce an audible phrase; said audible phrase being related with at least one said sensor input signal received by said processing unit from at least one said respective originating sensor input device.

26. A system for entertaining a user as recited in claim 23 wherein said first processing unit is accessible from without said apparatus for communication with a second processing unit.

27. A system for entertaining a user as recited in claim 24 wherein said first processing unit is accessible from without said apparatus for communication with a second processing unit.

28. A system for entertaining a user as recited in claim 25 wherein said first processing unit is accessible from without said apparatus for communication with a second processing unit.

29. A system for entertaining a user as recited in claim 26 wherein said first processing unit cooperates with said second processing unit to alter said audible phrase for at least one combination of signals provided to said first processing unit from said at least one respective originating sensor input device.

30. A system for entertaining a user as recited in claim 27 wherein said first processing unit cooperates with said second processing unit to alter said audible phrase for at least one combination of signals provided to said first processing unit from said at least one respective originating sensor input device.

31. A system for entertaining a user as recited in claim 28 wherein said first processing unit cooperates with said second processing unit to alter said audible phrase for at least one combination of signals provided to said first processing unit from said at least one respective originating sensor input device.

32. A system for entertaining a user as recited in claim 23 wherein said first processing unit is powered by a battery device in said apparatus.

33. A system for entertaining a user as recited in claim 25 wherein said first processing unit is powered by a battery device in said apparatus.

34. A system for entertaining a user as recited in claim 26 wherein said first processing unit is powered by a battery device in said apparatus.

35. A system for entertaining a user as recited in claim 32 wherein said battery device is accessible from without said apparatus for effecting battery charging operations.

36. A system for entertaining a user as recited in claim 33 wherein said battery device is accessible from without said apparatus for effecting battery charging operations.

37. A system for entertaining a user as recited in claim 34 wherein said battery device is accessible from without said apparatus for effecting battery charging operations.

38. A play system for entertaining a user; the system comprising:
(a) an anthropoid doll; said doll being configured to represent a torso a head and a plurality of limbs including two arms and two legs; said apparatus having a first processing unit coupled with a plurality of sensor input devices; said plurality of sensor input devices including at least one radio frequency identification receiver device; each respective sensor input device of said plurality of sensor input devices being a respective originating sensor input device providing a respective sensor signal to said first processing unit; each said respective sensor input signal indicating a respective parameter sensed by its respective originating sensor input device; said at least one radio frequency identification receiver device being at least a respective radio frequency identification receiver device situated in said torso, situated in said head and attached with selected limbs of said plurality of limbs;
(b) a plurality of accessory items for use with said doll; at least one selected accessory item of said plurality of accessory items bearing a radio frequency identifying indicium; each said respective radio frequency identifying indicium distinguishing a respective said selected accessory item;
said first processing unit being programmed to cooperate with said at least one radio frequency identification receiver device for recognizing said at least one selected accessory item by said radio frequency identifying indicium.

39. A play system for entertaining a user as recited in claim 38 wherein the system further comprises an audio speaker device coupled with said first processing unit.

40. A play system for entertaining a user as recited in claim 39 wherein said first processing unit, at least one said respective originating sensor input device and said audio speaker device cooperate to produce an audible phrase; said audible phrase being related with at least one said sensor input signal received by said processing unit from at least one said respective originating sensor input device.

41. A play system for entertaining a user as recited in claim 38 wherein said first processing unit is accessible from without said apparatus for communication with a second processing unit.

42. A play system for entertaining a user as recited in claim 39 wherein said first processing unit is accessible from without said doll for communication with a second processing unit.

43. A play system for entertaining a user as recited in claim 40 wherein said first processing unit is accessible from without said doll for communication with a second processing unit.

44. A play system for entertaining a user as recited in claim 41 wherein said first processing unit cooperates with said second processing unit to alter said audible phrase for at least one combination of signals provided to said first processing unit from said at least one respective originating sensor input device.

45. A play system for entertaining a user as recited in claim 42 wherein said first processing unit cooperates with said second processing unit to alter said audible phrase for at least one combination of signals provided to said first processing unit from said at least one respective originating sensor input device.

46. A play system for entertaining a user as recited in claim 43 wherein said first processing unit cooperates with said second processing unit to alter said audible phrase for at least one combination of signals provided to said first processing unit from said at least one respective originating sensor input device.

47. A play system for entertaining a user as recited in claim 38 wherein said first processing unit is powered by a battery device in said doll.

48. A play system for entertaining a user as recited in claim 40 wherein said first processing unit is powered by a battery device in said doll.

49. A play system for entertaining a user as recited in claim 43 wherein said first processing unit is powered by a battery device in said doll.

50. A play system for entertaining a user as recited in claim 47 wherein said battery device is accessible from without said apparatus for effecting battery charging operations.

51. A play system for entertaining a user as recited in claim 48 wherein said battery device is accessible from without said apparatus for effecting battery charging operations.

52. A play system for entertaining a user as recited in claim 49 wherein said battery device is accessible from without said apparatus for effecting battery charging operations.
